(19) United States
(12) Patent Application Publication
(10) Pub. No.: US 2005/0228785 A1
(43) Pub. Date: Oct. 13, 2005

(54) Method of diagnosing and managing memory impairment using images

(75) Inventors: Dana W. Wolcott, Honeoye Falls, NY (US); Edward Covannon, Ontario, NY (US); Elena A. Fedorovskaya, Pittsford, NY (US); Loretta E. Allen, Hilton, NY (US); David L. Patton, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/919,060

(22) Filed: Aug. 16, 2004

Related U.S. Application Data
(60) Provisional application No. 60/559,616, filed on Apr. 2, 2004.

(51) Int. Cl. G06F 17/30

(52) U.S. Cl. 707/3

(57) ABSTRACT

A method of managing a psychological state of an individual using images. The method comprises the steps of: creating a personal profile for an individual wherein the personal profile defines characteristics which are representative of personal experiences or memories of the individual; selecting a first set of images comprising personal images obtained from the individual or the individual's social network which include characteristics that match the characteristics of the personal profile; and displaying the selected first set of images to the individual to manage the psychological state of the individual.

### CROSS REFERENCE TO RELATED APPLICATION

Reference is made and priority is claimed from U.S. Provisional Patent Application No. 60/559,616 (Kodak Docket No. 87969), entitled “METHOD OF MANAGING MEMORY IMPAIRMENT USING IMAGES”, filed on Apr. 2, 2004 in the names of Wolcott et al., and which is assigned to the assignee of this application and incorporated herein by reference.

### FIELD OF THE INVENTION

The present invention relates to the field of measuring and helping individuals manage their memory impairment, by utilizing images or stimuli along with or as part of a biofeedback mechanism to reduce memory impairment.

### BACKGROUND OF THE INVENTION

Many elderly people experience increasing loss of memory due to disease or advanced age. The loss of memory associated with aging and disease can be frustrating to the person suffering the memory loss, and can lead to depression and other problems. Memory loss can be associated with events such as trauma and stroke, and also with diseases such as Dementia, Alzheimer's Disease, Down Syndrome, and Parkinson's Disease.

Various therapies and treatments have been proposed in attempts to treat such problems. For example, Dr. Linda Clare mentions in “Neuropsychology” (October, 2002) a study conducted regarding systematic memory training for the benefit of Alzheimer's patients. Also, U.S. Pat. No. 6,270,077 (Cohen) describes a non-competitive board game directed at memory enhancement.

While such systems may have achieved certain degrees of success in their particular applications, such therapies and treatments do not provide for the profiling of an individual so as to provide for customized images, which are specifically tailored for the individual so as to aid in the diagnosis of, and reduce or manage stress/frustration which can be associated with memory loss.

### SUMMARY OF THE INVENTION

An object of the present invention is to provide a method for managing a psychological state of an individual using images.

Another object of the present invention is to provide a method of managing memory impairment using images.

Another object of the present invention is to provide a method for memory enhancement of an individual.

A further object of the present invention is to provide a method of assessing memory impairment of an individual.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is a method of managing a psychological state of an individual using images. The method comprises the steps of: creating a personal profile (which can alternatively be referred to as a personalized profile) for an individual wherein the personal profile defines characteristics which are representative of personal experiences or memories of the individual; selecting a first set of images comprising personal images obtained from the individual or the individual's social network or images from a repository which has been created from a wider collection of images (e.g., wider than a personal collection or a collection derived from a social network) which can also be referred as “epochal” images which are nonetheless appropriate to the purpose and which include characteristics that match the characteristics of the personal profile; and displaying the selected first set of images to the individual to manage the psychological state of the individual.

According to another aspect of the invention, there is a method of managing memory impairment of an individual using images. The method comprises the steps of: creating a personal profile for an individual wherein the personal profile defines characteristics which are representative of personal experiences or memories of the individual; selecting a first set of images comprising personal images obtained from the individual or the individual's social network which include characteristics that match the characteristics of the personal profile; or images from a repository which has been created from a wider collection (i.e., wider than a personal collection or a collection derived from a social network) of images henceforth also known as “epochal” images which are nonetheless appropriate to the purpose and displaying the selected first set of images to the individual to manage the memory impairment of the individual.

According to yet another aspect of the invention, there is a method of memory enhancement for an individual. The method comprises the steps of: creating a personal profile for an individual wherein the personal profile defines characteristics which are representative of personal experiences or memories of the individual; selecting a first set of images comprising personal images obtained from the individual or the individual's social network or images from a repository which has been created from a wider collection (i.e., wider than a personal collection or a collection derived from a social network) of images which are nonetheless appropriate to the purpose and which include characteristics that match the characteristics of the personal profile; and displaying the selected first set of images to the individual to enhance the memory of the individual.

According to still another aspect of the invention, there is a method of assessing memory impairment of an individual. The method comprises the steps of: creating a personal profile for an individual wherein the personal profile defines characteristics which are representative of personal experiences or memories of the individual; selecting a first set of images comprising personal images obtained from the individual or the individual's social network or images from a repository which has been created from a wider collection (i.e., wider than a personal collection or a collection derived from a social network) of images which are nonetheless appropriate to the purpose and which include characteristics that match the characteristics of the personal profile; assigning a time period to each image of the selected first set of images; displaying the selected first set of images to the individual in accordance with the assigned time period; and monitoring the response of the individual to the displayed images to identify a time period associated with memory impairment of the individual.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a schematic view of an imager apparatus which can be employed with the method of the present invention.

FIG. 2 shows a flowchart illustrating a method in accordance with the present invention of managing memory impairment of an individual using images.

FIG. 3 shows a schematic figure of a flowchart for the collection of information by which to create a personal profile.

FIG. 4 shows a schematic figure of a flowchart for the collection of information by which to create personalized multimedia.

FIG. 5 shows a flowchart illustrating a method in accordance with the present invention of assessing memory impairment of an individual using images.

### DETAILED DESCRIPTION OF THE INVENTION

The following is a detailed description of the preferred embodiments of the invention, reference being made to the drawings in which the same reference numerals identify the same elements of structure in each of the several figures.

As indicated above, attempts have been made to treat individuals with dementia, particularly the type resulting from Alzheimer's disease. Applicants have recognized that sights and sounds from an individual's past can have a beneficial effect when used as part of a therapy tool. Generally, the present invention provides for a treatment by employing personal images. A collection of personal images can be generated by obtaining images from the individual's social network, generating a personal profile and using the profile to augment the collection of personal images with images from varied resources having images likely to be associated with the time and place of the individual's past. Such images can be drawn, for example, from hometown newspapers, school yearbooks, preferred music of the time, favorite movies local national and international periodicals, as well as and images created from historical records both visual and verbal of the time. Personal images can have a therapeutic effect on individuals with dementia. The present invention can further employ personal images with images associated with a particular memory/era, and can further include multimedia aspects, such as sound, aroma, taste, texture, motion pictures, videos and the like. The display can be an interactive display for playback as memory therapy and can use current technologies to enhance the experience. For example, although the music may have been stored on a monaural recording, the playback may be enhanced by adding stereo separation or if an image may have been stored in black and white and monocular, it may be reconstructed to be in color and stereoscopic.

Assessment of the individual's memory can be performed by employing memory tracks. Memory tracks are a collection of images intended for display in a series. Memory tracks can be built and added to, for example, as the individual repeats a satisfying track. An exemplary memory track includes a sequence of images representing a temporal sequence of events or specific occasions that the individual is asked to describe or recall. The events/occasions can be depicted with greater or lesser detail requiring more or less detailed recollections from the person. To create representative and rich pictorial descriptions of events/occasions, personal images obtained directly from the person or his/her social networks can be supplemented by historical/epochal images available by means of image banks, archives, or the like.

In order to test whether the individual's recollections are correct, adequate descriptions of the image sequences would preferably be available for verifying the responses. One way of storing such descriptions can be accomplished by including/attaching corresponding information (such as metadata) to each image or set of images. Other ways can include separate files, hardcopy documents, and the like including such data.

A characteristic of the memory tracks which promotes them as a relevant tool in assessing memory impairments is related to their organization according to the calendar time and the degree of detail. This organization allows for assessment of a temporal memory horizon and determination therefore of the degree of intact versus impaired short- and long-term memory. Expected beneficial effects include decreased agitation, depression, and anxiety, and improved quality of life. The method of the present invention is intended as a tool/method for delaying the onset of debilitating effects to an individual's memory from diseases by training unaffected parts of the brain to compensate for the loss of short-term memory. The method of the present invention employs personal and epochal images, and intended as therapy for individuals in an early stage of a memory impairing disease and can be used by health professionals (such as a doctor, nurse, social worker or the like) or non-health professionals (such as a colleague, relative, and the like).

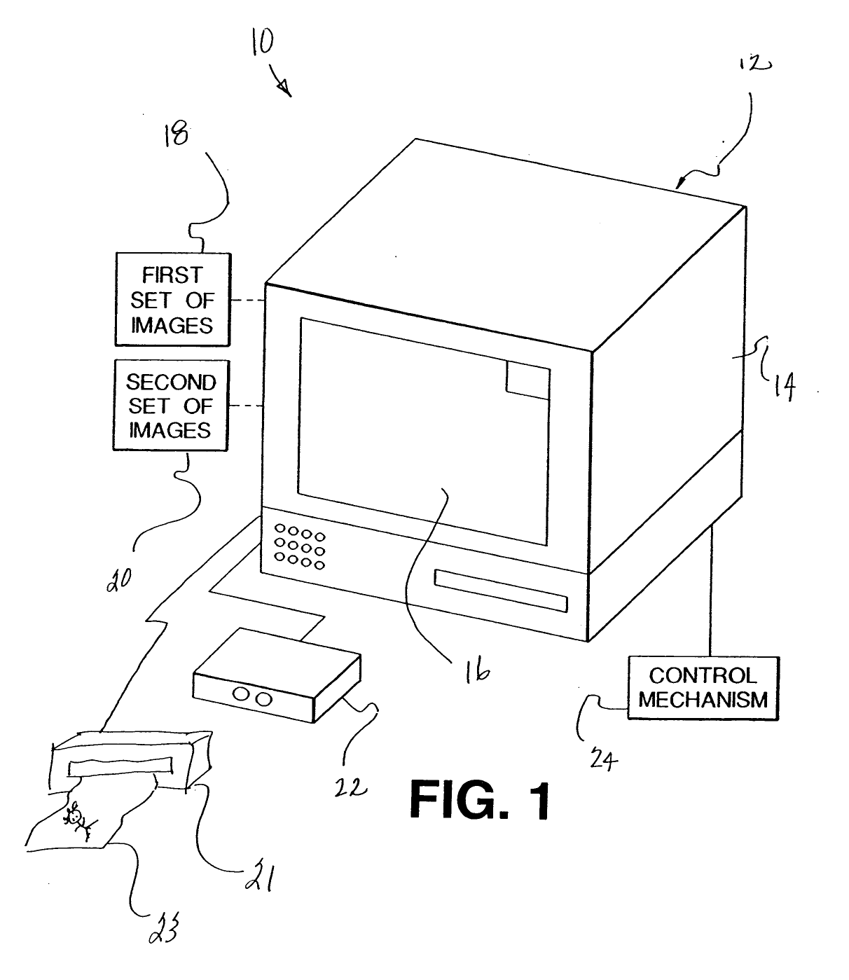

U.S. Pat. No. 6,102,846 (Patton), commonly assigned and incorporated herein by reference, describes a system which can be employed to manage a psychological and physiological state of an individual. Features of such a system can be employed with the method of the present invention. Referring to FIG. 1, there is illustrated a schematic view of the system 10 which includes a biofeedback imager apparatus 12 that can be utilized to monitor and manage a psychological state of an individual. That is, imager apparatus 12 is utilized by an individual as a memory impairment management mechanism. Although the present invention will be primarily described in terms of using images as a component of a memory impairment management mechanism, it is recognized that other stimuli such as sound, smell, etc. can be presented to the individual and utilized within the context of the present invention.

As illustrated in FIG. 1, imager apparatus 12 comprises an image display device 14 having a display 16. Image display device 14 can be a computer or some form of electrical imaging device such as a Photo CD player, slide projector, CD player, VCR, DVD player, television, hand held device such as a GAME BOY, BlackBerry device, PDA (personal digital assistant) or the like which can be compatible with a computer. Furthermore, image display device 14 can be correlated with a heating or vibrating assembly which can apply heat or movement to the chair on which the individual is seated in order to alter the person's environment. Other means of altering a person's environment are familiar to those versed in the art of virtual reality system design.

Image display device 14 can store a first set of images 18 on, for example, a disk or storage card, which are representative of a personalized image profile for an individual, the details of which will be described later. Image display device 14 can further be adapted to store and display a second set of images 20 from an image library or other sources of non-personal images, which can be stored therein by way of, for example, a disk, storage card or network server. The images can be still images, audio-visual images, video clips, or the like.

First set of images 18 can be displayed on display 16, or alternatively, first set of images can be printed using a printer 21 by which to provide a hardcopy 23 of the image(s).

FIG. 1 further illustrates a detector device 22 which can be operationally associated with image display device 14. Detector device 22 can be a measuring or monitoring apparatus that can interact with a user's body so as to measure physiological characteristics, such as galvanic skin response, a temperature of the extremities such as the fingers, a blood pressure, a pulse rate, breathing, eye movements, or other functions of an individual that can be related to the user's psychological state and thereby the user's level of stress. Detector device 22 can be attachable to a user's body in a non-invasive manner or could be a device that does not contact the user's body such as an optical monitor which can be used to measure the pupil dilation of the user's eye or eye saccades.

Image display device 14 can further include a control mechanism 24 which can comprise software to interact with detector device 22 and image display device 14, so as to control/affect the display of a particular image with regard to frequency, overall appearance (brightness, contrast, color balance, color saturation, size) and the appearance of particular objects with the image (e.g., causing particular objects to be emphasized by heightening shadow, contrast or color), or the method of how the images are displayed on display 16 based on the measured physiological characteristics of the individual. This method can include aspects such as pan, fade, zoom, timing, etc. as well as characteristics of image rendering such as contrast, brightness, color, and the like.

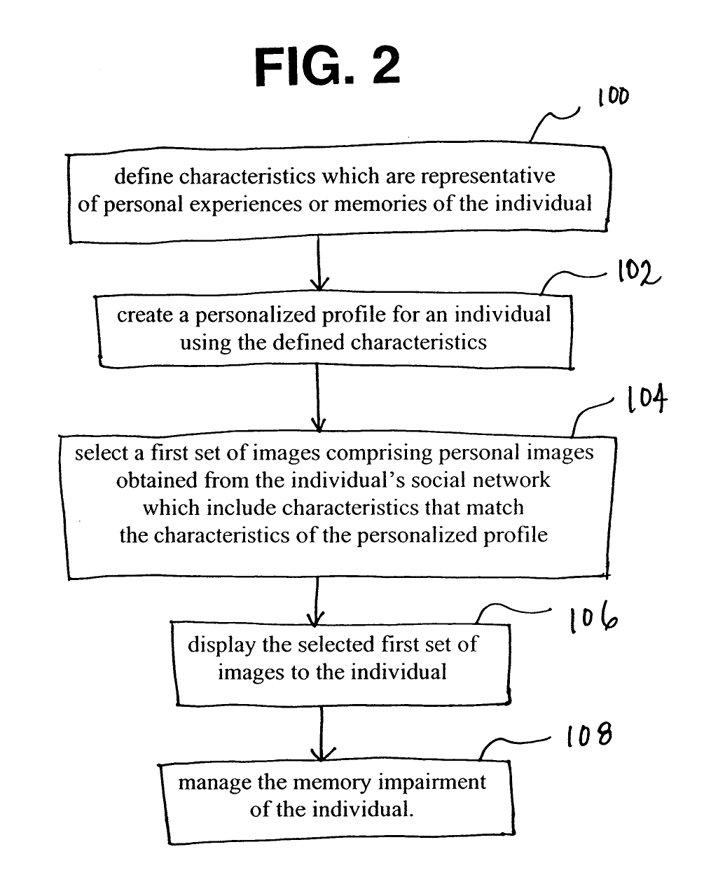

A method of managing memory impairment of an individual using images is generally described with reference to the flowchart shown in FIG. 2. At step 100, characteristics are defined which are representative of personal experiences or memories of the individual, for example, but not limited to, significant personal life events; significant general events, significant locations and objects all correlated to the individuals life stages. Then, at step 102, a personal profile is created for the individual using the defined characteristics. As such, a personal profile has now been created for the individual wherein the personal profile defines characteristics which are representative of personal experiences or memories of the individual. At step 104, first set of images 18 is selected. First set of images 18 comprises personal images obtained from the individual's social network which include characteristics that match the characteristics of the personal profile. The selected first set of images 18 is displayed to the individual (step 106) to diagnose or manage the memory impairment of the individual (step 108).

While determining the memory impairment, the memory recollections expressed verbally or detected using other methods (for example, by means of registration of physiological responses, such as bio-signals recorded from the brain or other signals) are recorded and compared with the anticipated correct responses. The error rate can be indicative of the severity of the memory impairment.

To manage the impairment, the images are shown to the individual and the associated information is then provided to the patient for memorizing, using a technique described for example by Dr. Linda Clare in “Neuropsychology” (October, 2002), incorporated herein by reference. This technique of picture-name association has been shown to produce short-term memory improvements in Alzheimer's patients. While the author used generic images to demonstrate the learning effect, Applicants believe that using personal images will further enhance the effect, firstly, because of the positive emotional associations the patient has with the depicted events or people, and secondly, because of the emotional associations with the multimodal nature of life experiences that the images remind them of.

The steps described above will now be more particularly described with reference to FIGS. 2-5.

By “social network” it is meant social contacts made by the individual, which can include relatives/family, friends and non-relatives, and can be made through direct contact (for example, through direct meetings, events, and the like) or non-direct contact (for example, through telephone correspondence, written correspondence, internet communication, and the like).

With regard to steps 100 and 102, wherein the personal profile is created, such a personal profile can be created by obtaining an initial level of information about the individual's personal history either directly from the individual or indirectly from the individual's social network wherein the information is obtained by question and answer means, for example, using a survey or interview process. This initial level of information can then be employed to derive a second level of information about the individual's history. For example, the initial level of information can include such personal information as date and location of birth, school attended, and family information. The second level of information can then be derived regarding the person's experiences that have not been directly asked. For instance, if it is learned that the individual was born in the 1850s and lived on a rural farm in the mid-west, it could be derived that the individual had to pump water by hand from a well. Similarly, if the individual lived in a suburb in the 1950s, it would be reasonable to expect that the individual had seen flooring, paneling, furniture and appliances in colors typical of the time period.

The personal profile can be generated using personal history information, including age, sex, and marital status, and can also include parameters such as, but not limited to, place of birth, family and economic background, and memorable historic events. The personal profile can include sights and sounds that reflect these parameters, and which are meaningful to the individual. Sight and sound matter can come in the form of family and vacation photos or home movies directly from the subject; from a friend or family member; or from a vendor. It is important to note that third-party matter (such as from a vendor) must be meaningful to the individual subject, and be based on the characteristics. For example, if the parameter for “place of birth” in a is NYC, then third-party matter would be images of the NYC skyline as it appeared during the time of the individual's youth. Another example might be the sound of a train conductor announcing, “next stop, Grand Central Station”.

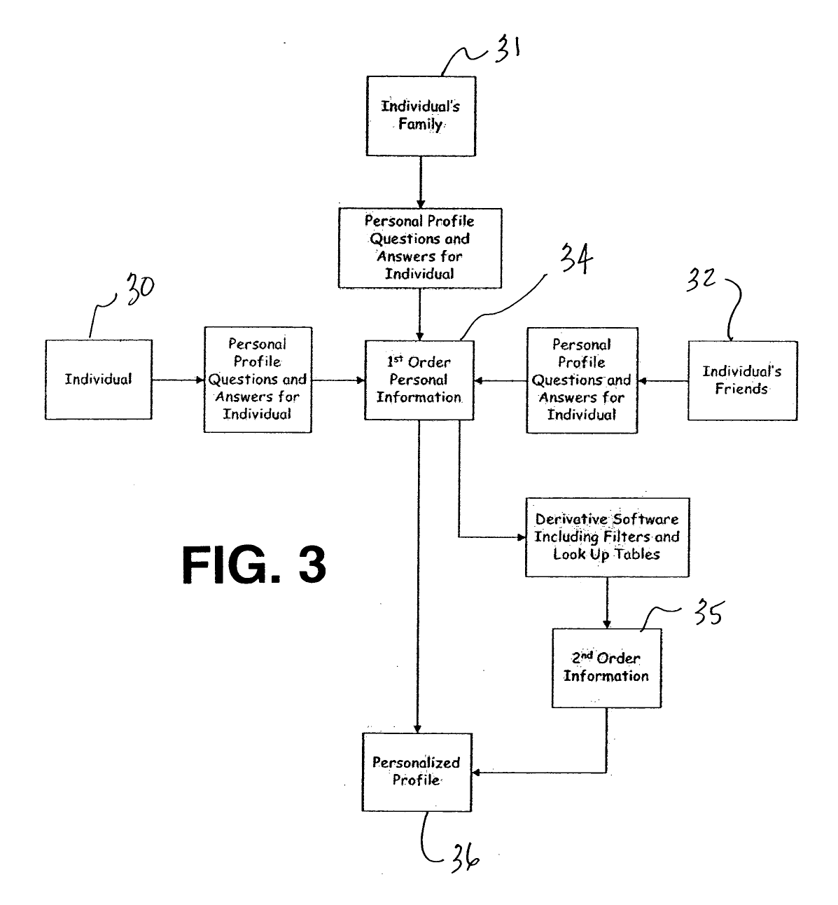

FIG. 3 generally shows a schematic figure of a flowchart for the collection of information by which to create a personal profile. As illustrated, the individual 31, the individual's family 32, or the individual's friends 33 can answer questions by which to provide an initial level of information 34, by which to create the personalize profile 36. In addition, software, fuzzy logic, expert system, neural networks and artificial intelligence methods can be employed to derive a second level of information 35 by which to create the personal profile 36.

Examples of characteristics which might define a sample personal profile include when and where the individual was born, what hobbies the individual had, what was the individual's first car, what jobs they held, and the like.

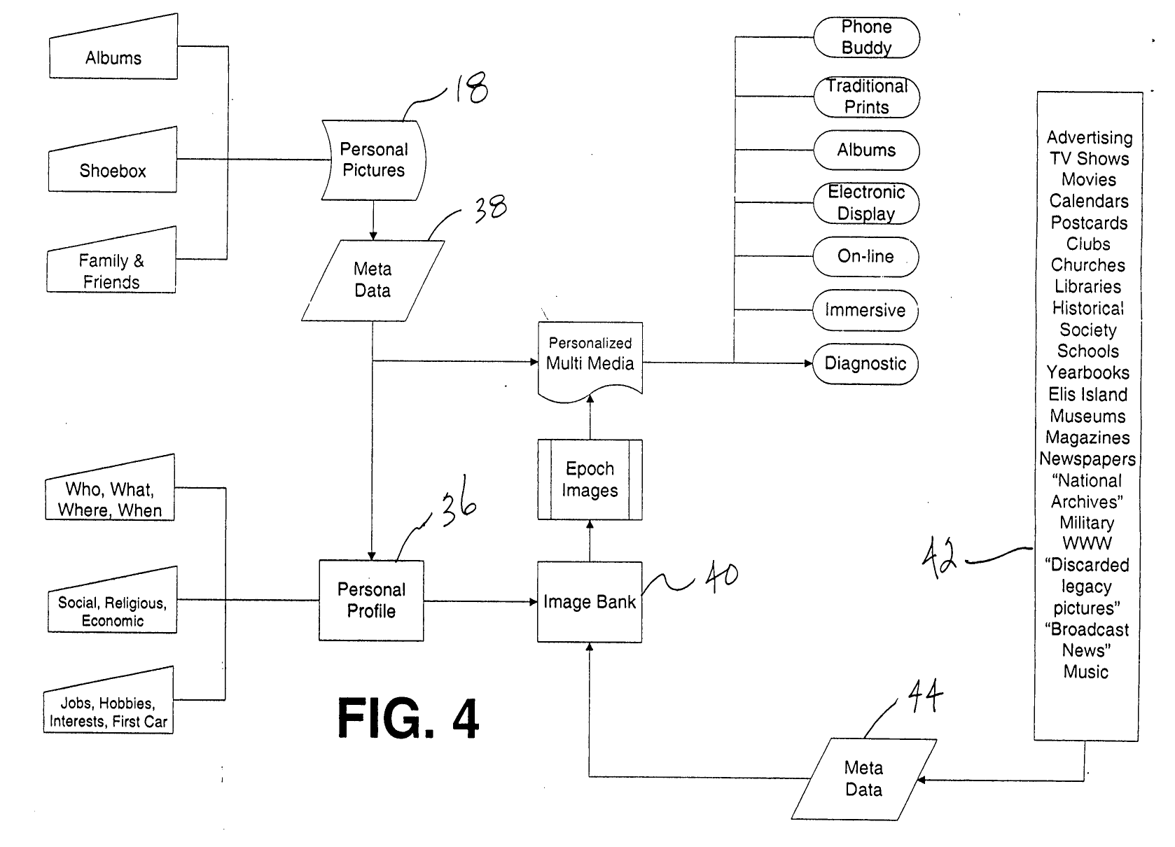

As indicated above, step 104 involves the step of selecting first set of images 18 comprising personal images obtained from the individual or the individual's social network which include characteristics that match the characteristics of the personal profile. Referring to FIG. 4, first set of images 18 can be obtained from the individual or the individual's social network. Stacks of images, photo albums, computer CDs, photographic negatives and the like are possible sources of images from which to select first set of images 18 which include matching characteristics.

In addition to the object data regarding what is within (e.g., the content) the images, and relational data that defines the organizational relation of the images to each other, metadata 38 might be associated with each of the images so as to promote the selection of the images which include characteristics that match the characteristics of the personal profile. For example, if the personal profile includes the characteristic of where the individual was born and the answer is “Rochester, N.Y.”, then images associated with metadata having the words “Rochester” or “Monroe County” or “upstate New York” and associated dates might be reviewed for selection.

Second set of images 20 can also be employed for display to the individual. That is, second set of images 20 can be selected from an image library/bank 40, wherein the images selected include characteristics that match the characteristics of the personal profile. Image banks are well known, and their content can be obtained from, but not limited to, sources 42 indicated in FIG. 4.

As with the first set of images 18, metadata 44 might be associated with the images of second set of images 20.

Steps of the method described in FIG. 2 can also be employed for a memory enhancement method for an individual. That is, a method for enhancing the memory of an individual can comprise the steps of: creating a personal profile for an individual wherein the personal profile defines characteristics which are representative of personal experiences or memories of the individual; selecting a first set of images comprising personal images obtained from the individual or the individual's social network which include characteristics that match the characteristics of the personal profile; and displaying the selected first set of images to the individual to enhance the memory of the individual.

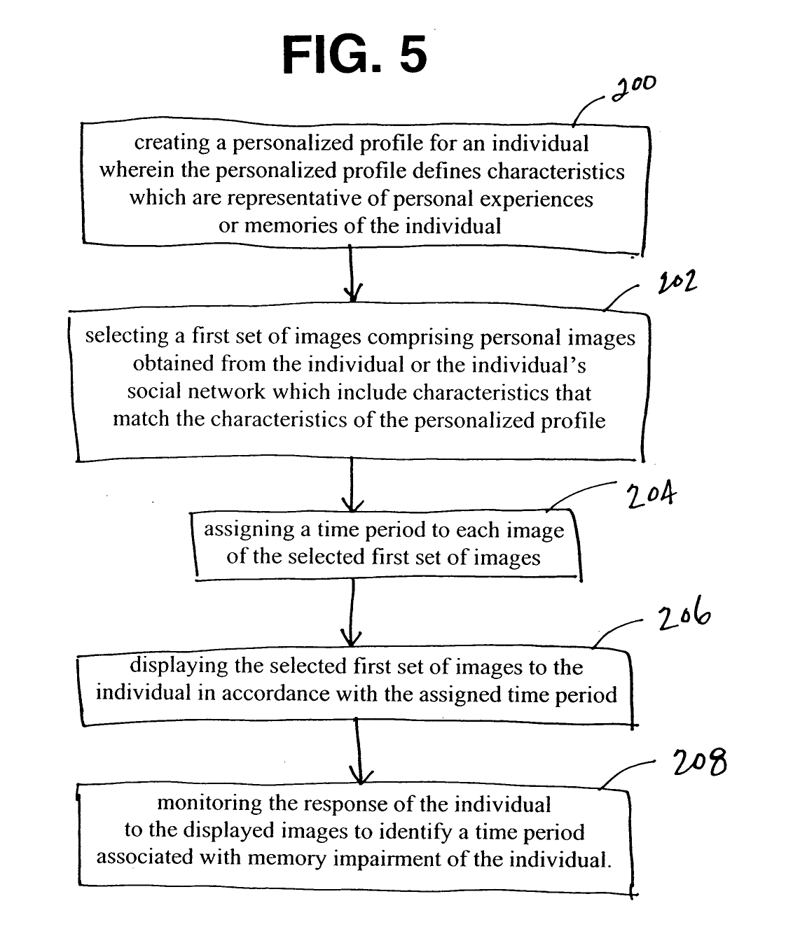

The present invention also provides a method of assessing a memory impairment of individuals using images. Such a method is generally described with reference to the flowchart shown in FIG. 5. As shown in FIG. 5, at step 200, personal profile is created for an individual wherein the personal profile defines characteristics which are representative of personal experiences or memories of the individual. Then, at step 202, a first set of images is selected wherein the first set of images comprises personal images obtained from the individual or the individual's social network which include characteristics that match the characteristics of the personal profile. Steps 200 and 202 can be accomplished as described above with regard to steps 100, 102, and 104. A time period or date stamp is assigned or associated with each image of the selected first set of images (step 204). By placing the images in an order associated with time, an epoch can be created. Then, the selected first set of images is displayed to the individual in accordance with the assigned time period (step 206), wherein such display can be a softcopy display on display 16 or a hardcopy display 23. At step 208, a response of the individual to the displayed images is monitored to identify a time period associated with memory impairment of the individual. The step of monitoring the response includes the step of monitoring the psychological or physiological state of the individual.

Step 208, the step of monitoring the response, can include the step of monitoring the psychological or physiological state of the individual. One method of monitoring the psychological or physiological state of the individual is described in U.S. Pat. No. 6,102,846 (Patton), incorporated herein by reference. U.S. Pat. No. 6,293,904 (Blazey), incorporated herein by reference, describes a method of managing a psychological or physiological state of the individual. For example, the individual is shown images starting with an early period such as when the individual was in their late teens and early twenties and progresses to the present time period. The individual's stress level is monitored, for example, using anyone of the methods previously described. Because the individual believes they should be able to recognize the images they are being shown, their stress level will increase if they fail to recognize an image(s).

Using this method, a time period can be determined over which the individual retains memories and/or has not retained memories. From this determination, health care professionals can monitor/diagnose the type of disease such as Alzheimer's Disease, its severity or stage, and make therapy recommendations for the individual.

To promote the managing of the memory impairment, it may be desired to manage the physiological state of the individual prior to displaying the selected first set of images. That is, it has been suggested that memory training can be enhanced by placing the individual in a predetermined physiological state. Accordingly, in another embodiment of the present invention, the physiological state of the individual is managed prior to displaying the selected first set of images to the individual.

In a preferred embodiment, the individual is placed in a physiological state of arousal of appropriate level since at least one commentator has noted a link between arousal level and emotions and performance, referring to Yerkes, R. M. & Dodson, J. D. “The Relationship of Strength of Stimulus to Rapidity of Habit Formation. Journal of Comparative Neurology and Psychology. 1908, 18, 459-482, incorporated herein by reference. According to Berlyne, there is an optimal level of arousal for an individual at a given time. See Berlyne, D. (1960). Conflict, Arousal, and Curiosity. New York: McGraw-Hill. See also MacWhinney et al “The role of arousal in memory for conversation”, Psychonomic Society, Inc, 1982, discussing the role of arousal in memory for conversation, all incorporated herein by reference.

Managing the physiological state of the individual can be accomplished using the method taught in U.S. Pat. No. 6,102,846 (Patton) incorporated herein by reference. Such management is accomplished by the steps of: (1) creating a personalized preferred image response profile for the individual by having the individual view a third set of images and choosing images from the third set of images which provide a preferred response for the individual, wherein said personalized preferred image response profile defines preferred characteristics which are representative of common characteristics of the chosen images; (2) selecting a fourth set of images from an image library which include characteristics that match the preferred characteristics of the personalized preferred image response profile; and (3) displaying the selected fourth set of images to the individual to manage the physiological state of the individual.

That is, the personalized preferred image response profile is created by having an individual look at a wide variety of images and measuring the effects of the images on the individual's psychological state as indicated by their physiological state. The measurements can be made by recording the person's EMG, EEG (directly or to measure for P300 latency), galvanic skin response, PET, MRI, skin temperature, heart rate, blood pressure, eye movement, pupil dilation or any measurable indication of stress. The measurements are matched to the image the individual was viewing at the time and show how the individual reacts to a specific image or set of images. From this data, a personalized preferred image response profile is created for each individual. A third set of images will generally be those images which provide a preferred response, such as a lowering of a stress level of the individual. Therefore, the personalized preferred image response profile can include data from the third set of images which is representative of common characteristics, or attributes of the first set of images which tend to provide a preferred response to the individual. The personalized preferred image response profile can then be used to select images from an image library which includes a fourth set of images. The selected images can be used by the individual as their personal biofeedback images, and thus, by using the personalized preferred image response profile, images are selected that have a desired effect for the individual. More generally, the personalized preferred image response profile may be comprised of a set of information that describes the selected images and others that match the response profile.

As an example, to use his or her personalized preferred image response profile, the individual accesses an image library (for example, via the Internet or interactive CD-ROM), and keys in a number that links to their personalized preferred image response profile via a code. The individual's personalized preferred image response profile is then used by the image library to select images from the image library. Thumb nails (small low resolution images) of these selected images can be shown to the individual so that the individual can chose from the selected images, the images he or she wants and the order of the images, before the images are downloaded or sent to the individual for use as biofeedback in their personal biofeedback imager (i.e. a FLASH PIX format). The personalized image response profile allows the user to pick from a variety of categories such as seascapes, desert scenes, forest scenes or his or her own personal images such as from his or her house, garden or favorite museum to name a few examples. This allows the user to change the images that are used as biofeedback without the risk of the images having an adverse effect on the individual's mental state.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method of managing a psychological state of an individual using images, the method comprising the steps of:
creating a personal profile for an individual wherein the personal profile defines characteristics which are representative of personal experiences or memories of the individual;
selecting a first set of images comprising personal images obtained from the individual or the individual's social network which include characteristics that match the characteristics of the personal profile; and
displaying the selected first set of images to the individual to manage the psychological state of the individual.

2. The method of claim 1, wherein the step of creating a personal profile is accomplished by obtaining an initial level of information about the individual's personal history either directly from the individual or indirectly from the individual's social network

3. The method of claim 2, wherein the initial level of information is obtained by question and answer.

4. The method of claim 2, wherein the step of creating a personal profile further comprises the step of, after obtaining the initial level of information, deriving a second level of information about the individual's history using the initial level of information.

5. The method of claim 1, wherein the step of displaying is accomplished by displaying a hardcopy or a softcopy.

6. The method of claim 1, further comprising the steps of:
selecting a second set of images from an image library which includes characteristics that match the characteristics of the personal profile; and
displaying the selected first and second set of images to the individual.

7. The method of claim 1, further comprising the step of, prior to displaying the selected first set of images to the individual, managing the physiological state of the individual.

8. The method of claim 7, wherein the step of managing the physiological state of the individual is accomplished by the steps of:
creating a personalized preferred image response profile for the individual by having the individual view a third set of images and choosing images from the third set of images which provide a preferred response for the individual, wherein said personalized preferred image response profile defines preferred characteristics which are representative of common characteristics of the chosen images;
selecting a fourth set of images from an image library which include characteristics that match the preferred characteristics of the personalized preferred image response profile; and
displaying the selected fourth set of images to the individual to manage the physiological state of the individual.

9. The method of claim 1, further comprising the step of assignment metadata to the first set of images.

10. The method of claim 1, further comprising the step of associating a multimedia element to the first set of images.

11. A method of managing memory impairment of an individual using images, the method comprising the steps of:
creating a personal profile for an individual wherein the personal profile defines characteristics which are representative of personal experiences or memories of the individual;
selecting a first set of images comprising personal images obtained from the individual or the individual's social network which include characteristics that match the characteristics of the personal profile; and
displaying the selected first set of images to the individual to manage the memory impairment of the individual.

12. A memory enhancement method for an individual, the method comprising the steps of:
creating a personal profile for an individual wherein the personal profile defines characteristics which are representative of personal experiences or memories of the individual;
selecting a first set of images comprising personal images obtained from the individual or the individual's social network which include characteristics that match the characteristics of the personal profile; and
displaying the selected first set of images to the individual to enhance the memory of the individual.

13. The method of claim 12, wherein the step of creating a personal profile is accomplished by obtaining an initial level of information about the individual's personal history either directly from the individual or indirectly from the individual's social network

14. The method of claim 12, wherein the step of displaying is accomplished by displaying a hardcopy or a softcopy.

15. The method of claim 12, further comprising the steps of:
selecting a second set of images from an image library which includes characteristics that match the characteristics of the personal profile; and
displaying the selected first and second set of images to the individual.

16. The method of claim 12, further comprising the step of, prior to displaying the selected first set of images to the individual, managing the physiological state of the individual.

17. The method of claim 16, wherein the step of managing the physiological state of the individual is accomplished by the steps of:
creating a personalized preferred image response profile for the individual by having the individual view a third set of images and choosing images from the third set of images which provide a preferred response for the individual, wherein said personalized preferred image response profile defines preferred characteristics which are representative of common characteristics of the chosen images;
selecting a fourth set of images from an image library which include characteristics that match the preferred characteristics of the personalized preferred image response profile; and
displaying the selected fourth set of images to the individual to manage the physiological state of the individual.

18. The method of claim 12, further comprising the step of assignment metadata to the first set of images.

19. The method of claim 12, further comprising the step of associating a multimedia element to the first set of images.

20. A method of assessing memory impairment of an individual, the method comprising the steps of:
creating a personal profile for an individual wherein the personal profile defines characteristics which are representative of personal experiences or memories of the individual;
selecting a first set of images comprising personal images obtained from the individual or the individual's social network which include characteristics that match the characteristics of the personal profile;
assigning a time period to each image of the selected first set of images;
displaying the selected first set of images to the individual in accordance with the assigned time period; and
monitoring the response of the individual to the displayed images to identify a time period associated with memory impairment of the individual.

21. The method of claim 20, wherein the step of monitoring the response includes the step of monitoring the psychological or physiological state of the individual.

22. The method of claim 21, further including the step of measuring the physiological state of the individual using biofeedback.

23. The method of claim 22, where the physiological state of the individual being measured is stress.

24. The method of claim 20, wherein the step of creating a personal profile is accomplished by obtaining an initial level of information about the individual's personal history either directly from the individual or indirectly from the individual's social network

25. The method of claim 20, wherein the step of displaying is accomplished by displaying a hardcopy or a softcopy.

26. The method of claim 20, further comprising the steps of:
selecting a second set of images from an image library which includes characteristics that match the characteristics of the personal profile; and
displaying the selected first and second set of images to the individual.

27. The method of claim 20, further comprising the step of, prior to displaying the selected first set of images to the individual, managing the physiological state of the individual.

28. The method of claim 27, wherein the step of managing the physiological state of the individual is accomplished by the steps of:
creating a personalized preferred image response profile for the individual by having the individual view a third set of images and choosing images from the third set of images which provide a preferred response for the individual, wherein said personalized preferred image response profile defines preferred characteristics which are representative of common characteristics of the chosen images;
selecting a fourth set of images from an image library which include characteristics that match the preferred characteristics of the personalized preferred image response profile; and
displaying the selected fourth set of images to the individual to manage the physiological state of the individual.

29. The method of claim 20, further comprising the step of assignment metadata to the first set of images.

30. The method of claim 20, further comprising the step of associating a multimedia element to the first set of images.

31. A computer storage product having at least one computer storage medium having instructions stored therein causing one or more computers to perform the method of claim 1.

32. A method of determining a psychological state of an individual using images, the method comprising the steps of:
creating a personal profile for an individual wherein the personal profile defines characteristics which are representative of personal experiences or memories of the individual;
selecting a first set of images comprising images obtained from the individual or the individual's social network which include characteristics that match the characteristics of the personal profile, and cover a range of time from the individuals present through the individual's past;
time stamping the selected first set of images with a date associated with when the images where taken,
displaying the selected first set of images in a predetermined order to the individual to determine the individual's ability to remember the images; and
using the individual's ability to remember the images to determine the psychological state of an individual.

33. The method of claim 32, wherein the selected first set of images are personal images.

34. The method of claim 32, wherein the images are representative of significant events that occurred during the individual's life.

35. The method of claim 32, wherein the images are representative of significant locations to the individual.

36. The method of claim 32, wherein the method of determining a psychological state of an individual is used to diagnose diseases that affect the individual's memory.

37. A system of managing a psychological and physiological state of an individual using images, the system comprising:
an image display device which is adapted to store a personal profile of an individual, and to store and display a set of images from an image library; and
a detector device which measures physiological characteristics of the individual, wherein the physiological characteristics are indicative of a stress level of the individual;
wherein the image display device comprises a control mechanism which selects images from the set of images that includes attributes that match attributes of the personal profile, and displays the selected images in a desired sequence in accordance with a memory level of the individual as measured by the detector device, or qualified observer to manage a stress level of the individual.

38. A system according to claim 37, further comprising a selector device which includes a viewing screen which displays the selected time stamped images in a specific order and selector switches which enable an individual(s) viewing the images to change the order of the images, such that the desired psychological state of the individual based on the selected order of the images is achieved.

39. A system according to claim 38, wherein the selector device further includes a memory module for storing the selected images and the order in which the selected images were shown.
